(19) United States
(12) Patent Application Publication
(10) Pub. No.: US 2015/0090771 A1
(43) Pub. Date: Apr. 2, 2015

(54) METHOD AND SYSTEM FOR FABRICATING A MODULE

(71) Applicant: Airbus Operations GmbH, Hamburg (DE)

(72) Inventors: Domenico Furfari, Hamburg (DE); Marco Pacchione, Hamburg (DE); Valentin Richter-Trummer, Hamburg (DE)

(21) Appl. No.: 14/493,563

(22) Filed: Sep. 23, 2014

(30) Foreign Application Priority Data
Sep. 30, 2013 (EP) 13186578.4

(51) Int. Cl. B23K 31/00; B23K 26/24; B23K 31/12; B23K 26/00; B23K 20/12; B23K 31/02

(52) U.S. Cl. CPC B23K 31/003; B23K 20/12; B23K 31/02; B23K 31/12; B23K 26/0069; B23K 26/24; B23K 2201/006
USPC 228/104; 228/155; 228/114; 228/18; 228/9; 219/121.64; 219/121.63

(57) ABSTRACT

A method of fabricating a module for an airframe or fuselage structure of an aircraft or spacecraft includes positioning a first member adjacent to a second member at an assembly station; welding the first member to the second member at the assembly station to produce a module having a welded joint between the first and second members; and peening at least one of the first member, the second member, and the welded joint at the assembly station to compensate for or to correct distortion caused by the welding.

### CROSS-REFERENCE TO RELATED APPLICATION

This application claims the benefit of the European Patent Application No. 13186578.4 filed on Sep 30, 2013, the entire disclosures of which are incorporated herein by way of reference.

### BACKGROUND OF THE INVENTION

The present invention relates to a method and a system for fabricating a module, such as a stiffened panel, for an airframe or fuselage structure of an aircraft or spacecraft. The module fabricated according to the method and system of the invention comprises parts or members, typically of metal or a metal alloy, which are or may be welded together.

The method and system of the invention are especially suitable for use in fabrication of an airframe or fuselage structure of an aircraft or spacecraft, and it is convenient to describe the invention herein in this exemplary context. It will be appreciated, however, that the method and system of the invention are not limited to this application, but may be used to provide modules, such as panels, for the body structure of other vehicles, such as trains, automobiles, trucks or ships. Accordingly, the method and system of the invention may be suitable for a whole range of nautical, aeronautical, automotive and aerospace applications.

Current airframe and fuselage structures, including wing and tail structures of commercial aircraft, are typically built from panel modules which are joined together with fasteners, such as rivets. In recently developed commercial aircraft, welding has been used to join stiffener members, such as stringers, to skin panels. With current manufacturing techniques, however, the welding of stringers to skin panels often generates distortions (sometimes called the “Zeppelin effect”) which need to be corrected in separate manufacturing procedures. In other words, the welded and stiffened panels need to be transferred or transported to other processing stations for further treatment and this in turn significantly increases the workload and the lead times for the overall manufacturing process of integrally stiffened panel modules in aircraft manufacture.

### SUMMARY OF THE INVENTION

It is therefore an idea of the present invention to provide a new and improved method and system for overcoming one or more of the problems discussed above. In particular, it would be useful to provide a new method of fabricating a module for an airframe or fuselage structure of an aircraft which may enable a faster and/or more automated production procedure.

According to one aspect, the invention provides a method of fabricating a module for an airframe or fuselage structure of an aircraft or spacecraft, including the steps of positioning a first member adjacent to a second member at a work station or assembly station, welding the first member to the second member at the work station or assembly station to produce the module having a welded joint between the first and second members, and treating the first member, the second member, and/or the welded joint at the work station or assembly station to compensate for, or correct, distortion in the module caused by the welding.

In another embodiment, the step of treating the first member, the second member, and/or the welded joint at the work station or assembly station includes laser peening (also called “laser shock peening” (LSP) or “laser shot peening”). That is, the first member, the second member, or the welded joint may be laser peened. Laser peening is a process of hardening or peening metal using a powerful laser and typically involves generating high amplitude shock waves which are applied to a selected region of the module. The peak pressure of the shock waves typically exceeds the dynamic yield strength of a material of the module, i.e. the material of at least one of the first member, the second member, and/or the welded joint to which the shock waves are applied, and this in turn produces the laser peening effect. In a preferred embodiment, therefore, each of the first member and the second member is comprised of metal or metal alloy, such as an aluminium alloy. The laser peening may preferably also be employed to induce compressive stresses in the module, which may inhibit fatigue-induced weaknesses in the material. Laser peening can impart a layer of residual compressive stresses in a surface that is four times deeper than that which is attainable from conventional shot peening treatments.

In another embodiment, the step of treating the first member, the second member, and/or the welded joint at the work station or assembly station to compensate for, or to correct, distortion caused by welding includes generating residual compressive stresses in a surface region of the module; i.e. a surface region of the first member, the second member, and/or the welded joint. To this end, the technique employed to generate the residual compressive stresses in a surface region may comprise peening, including any one or more of laser peening, shot peening, and sand-blasting. While laser peening provides for a highly precise treatment of a surface region of the module, the other techniques, such as shot peening or sand-blasting, can be performed substantially faster.

In another embodiment, the first member of the module is a stiffening member. For example, the first member may be an elongate member having a transverse cross-section or profile that may be e.g. I-shaped, C-shaped, Z-shaped, T-shaped, or L-shaped. The second member of the module, on the other hand, preferably comprises an area member, such as a sheet member or a panel, which may define a multi-dimensional surface area, such as a two- or three-dimensional surface area. As will be appreciated by persons skilled in the art, the module may include a number of first members (e.g. stiffening members) welded to the second member (e.g. an area member, sheet member, or panel).

The conventional riveting procedures used to construct and also to interconnect panel modules or shell sections in airframe and fuselage structures carries a significant weight penalty due to the need to overlap material along the riveted seams, and due to the inclusion of doublers, crack stoppers, and sealing material, not to mention the rivets themselves. Furthermore, the use of rivets is an expensive procedure despite the fact that the riveting procedures today are highly automated. As an alternative to riveting, welding has been contemplated. Conventional welding methods, however, generate distortions in the welded parts, especially in sheet members or panels, due to residual stresses induced in the material by thermal stresses during formation of the welded joint and/or due to a change in the microstructure of the material at the welded joint. These distortions in the welded parts thus require additional manufacturing operations which, in turn, result in greater lead times in airframe and fuselage structure assembly.

The present invention replaces the conventional manufacturing techniques with a method that is able to save weight and cost at same time. In particular, the present invention improves conventional assembly procedures in terms of cost reduction and time efficiency by correcting the distortion created by welding during the same manufacturing operation without generating additional lead time. That is, both the welding step and the peening step take place at the same work station or assembly station, and no separate manufacturing operations are required with the method of the invention.

In another embodiment, therefore, the invention provides a method of fabricating a panel module for an airframe or fuselage structure of an aircraft or spacecraft, including the steps of positioning a stiffening member on one side of a panel so that the stiffening member extends over said one side of the panel at a work station, welding the stiffening member to the panel at the work station to produce a panel module including a welded joint between the stiffening member and the panel, and laser peening the welded joint and/or the panel at the work station to compensate for, or correct, distortion in the stiffened panel module caused by the welding.

In another embodiment, the welding of the first member to the second member includes at least one of laser beam welding (LBW) and friction stir welding (FSW). Furthermore, the step of welding preferably involves butt welding or T-joint welding the first member to the second member. It will be understood that the method may include the step of clamping the first and second members together during the welding step to ensure proper positioning of the first member and the second member is maintained.

In another embodiment of the invention, the laser peening includes imparting laser beam pulses to one or more of the first member, the second member, and the welded joint through an overlay or coating. A coating, usually black tape or paint, may be applied to absorb the laser energy. Short energy pulses are then focused to explode the ablative coating, producing a shock wave with the laser. The beam is then repositioned and the process is repeated, creating an array of slight indentations of compression and depth with about 5-7% cold work. Preferably, a transparent overlay may also be provided. The transparent overlay may, for example, comprise a layer of liquid, such as water. The liquid may optionally flow over a surface of the module in the region of the laser shock peening. This translucent layer is provided over the coating and acts as a tamp, directing the shock wave into the treated material. In this way, the liquid may effect or perform cooling of the module in the region of the laser shock peening to prevent or limit thermal effects by the laser beam pulses. The laser peening process will typically be computer-controlled and may be repeated, e.g. as many as three times, until the desired compression level is reached, producing a compressive layer as deep as 1-2 mm average.

In another embodiment, the step of laser shock peening is carried out before, during and/or after the welding step. In this regard, the laser shock peening is preferably performed or carried out during the welding step (e.g. after material consolidation) to correct or counter-act the distortion in the first and/or second member caused by the welding. That is, the welding and laser peening (LSP) steps or operations may take place or be carried out substantially simultaneously or contemporaneously. It is to be noted, however, that the laser peening may also be performed or carried out before the welding step to compensate for, or counteract, subsequent deformation which occurs during or after the welding step. Alternatively, or in addition, the laser shock peening may be performed or carried out after the welding step.

In another embodiment of the invention, the method comprises: measuring or sensing a distortion in the module (e.g. in either or both of the first member and second member) during and/or after the welding step; and controlling the laser peening based on the distortion of the module that is measured or sensed. For example, the step of measuring or sensing the distortion in the module may comprise measuring or sensing reaction forces, or changes therein, in a clamping mechanism or device for positioning and holding the first member with respect to the second member during welding. Alternatively, or in addition, the measuring or sensing step may include detecting other property changes, such as surface strain, due to distortion of the first or second member. The size and location of the region to be laser peened may also be predicted based on welding process parameters and geometry details, thereby reducing a need for measurements during the manufacturing process.

According to another aspect, the present invention provides a system for fabricating a module, such as a stiffened panel module, for an airframe or fuselage structure of an aircraft or spacecraft. The system includes a frame for positioning and holding a first member with respect to and adjacent a second member, a welding head for producing a welded joint between the first member and the second member held by the frame, and a treatment head, especially a laser shock peening head, to compensate for or correct distortion in the module caused by welding.

In another embodiment, the welding head includes a laser for laser beam welding (LBW). As the laser shock peening head will typically also include a laser, the laser shock peening head is preferably included in or combined with the welding head. In this regard, the welding laser may be separate or distinct from the shock peening laser.

In another embodiment, the frame includes a clamping device or clamping mechanism for holding the first member clamped or fixed in position with respect to the second member. Thus, where, for example, the first member is a stiffening member and the second member is a sheet member or panel, the clamping device may be configured to hold or fix an elongate stiffening member adjacent one side or facing surface of the sheet member or panel.

In another embodiment, the system further comprises a sensor device or measuring device for sensing or measuring a distortion of either or both of the first and second members during welding. As noted above, for example, the sensor device or measuring device may sense or measure a distortion in the module based on reaction forces, or changes therein, in the clamping mechanism or clamping device with which the first member (e.g. stiffening member) is held with respect to the second member (e.g. panel) during welding. Thus, the sensor or measuring device may be incorporated in the clamping mechanism. Alternatively, or in addition, the sensor or measuring device may sense or measure other property changes, such as surface strain, due to distortion of the panel or stiffener member.

According to a further aspect, the present invention provides a method of fabricating a module for an airframe or fuselage structure of an aircraft or spacecraft, including the steps of positioning a first member adjacent to a second member at a work station or assembly station, welding the first member to the second member at the work station or assembly station to produce the module having a welded joint between the first and second members, and treating the first member, the second member, and/or the welded joint at the work station or assembly station to compensate for, or correct, distortion in the module caused by the welding. The method further provides generating residual compressive stresses in a surface region of the module, and generating a shock wave in a region of at least one of the first member, the second member, and the welded joint.

### BRIEF DESCRIPTION OF THE DRAWINGS

For a more complete understanding of the present invention and the advantages thereof, exemplary embodiments of the invention are explained in more detail in the following description with reference to the accompanying drawings, in which like reference characters designate like parts and in which:

FIG. 1 is a schematic perspective view of a section of a fuselage of an aircraft showing the lines of welded joints between fuselage panels or shells;

FIG. 2 is a schematic illustration of an arrangement and welding head for friction stir welding;

FIG. 3 is a schematic cross-sectional and perspective view of a stiffened panel which undergoes distortion due to a welded joint;

FIG. 4 is a schematic cross-sectional view of laser shock peening of a region of a stiffened panel according to an embodiment of the invention;

FIG. 5 is a schematic illustration of an aircraft having a fuselage including panel modules produced according to an embodiment of the invention;

FIG. 6 is a flow diagram which schematically illustrates a method according to an embodiment;

FIG. 7 is a flow diagram which schematically illustrates a method according to another embodiment; and

FIG. 8 is a flow diagram which schematically illustrates a method according to a further embodiment.

### DETAILED DESCRIPTION OF THE PREFERRED EMBODIMENTS

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will further be appreciated that certain actions and/or steps in an embodiment of a method may be described or depicted in a particular order of occurrences while those skilled in the art will understand that such specificity with respect to sequence is not necessarily required. It will also be understood that the terms and expressions used in the present specification have the ordinary meaning as is accorded to such terms and expressions with respect to their corresponding respective areas of inquiry and study, except where specific meanings have otherwise been set forth herein.

With reference firstly to FIG. 1 of the drawings, a schematic illustration of a tubular portion P of a fuselage structure F of an aircraft A is shown. The tubular portion P of the fuselage structure F of the aircraft A is assembled by interconnecting a number of panel modules or shell sections 1 with one another, including along seams or joints J extending longitudinally of the aircraft A. Conventionally, such longitudinal joints J would be formed by riveting. In the present embodiment, however, these seams or joints J are welded, preferably via butt welding, for example using friction stir welding (FSW), which is characterized by high mechanical strength properties under both static and dynamic loading.

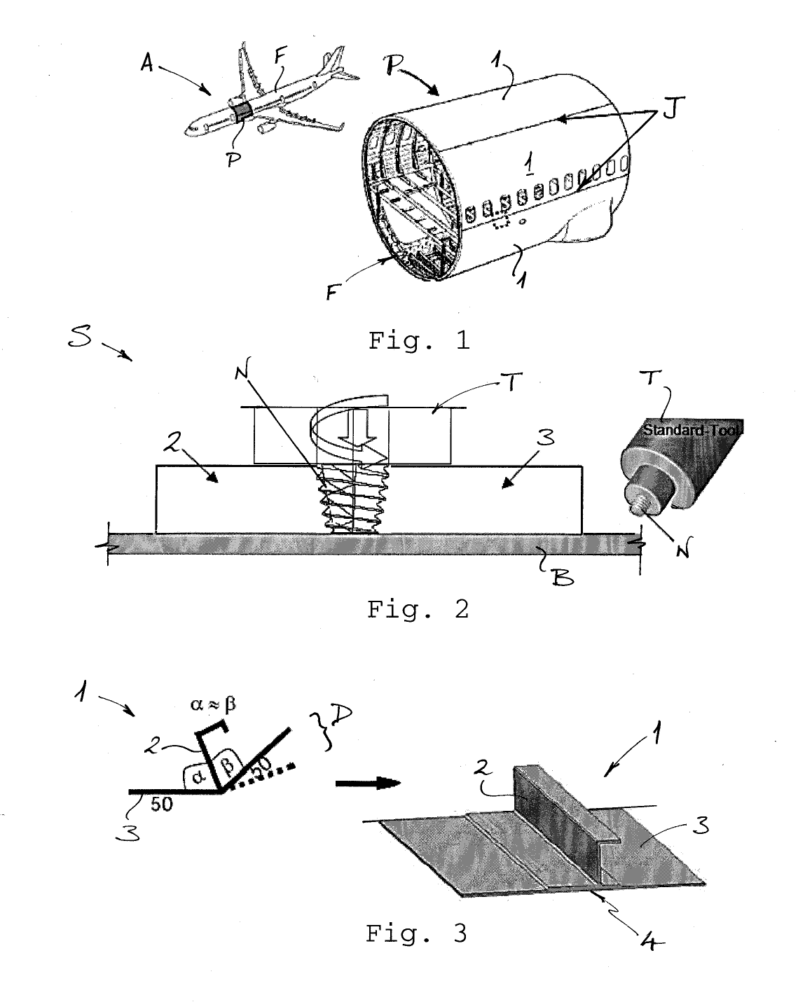

FIG. 2 of the drawings schematically illustrates formation of a butt weld between a first member 2 and a second member 3 using a friction stir welding (FSW) tool T. Each of these first and second members 2, 3 is comprised of an aluminium alloy, and the FSW tool T acts from one side of the material at the butt joint 4 between the first and second members 2, 3, as shown. In this embodiment, the first member 2 and the second member 3 are held clamped together in the butt joint 4 in a supporting frame of an assembly station S during the welding procedure. The supporting frame includes an assembly base or table B, and the FSW tool T includes a pin or probe N which engages the first and second members 2, 3 at the butt weld 4 supported against the base B. Alternatively, however, FSW tools T in the assembly station S could act on aluminium material of the first and second members 2, 3 from opposite sides thereof at the same time, such that the tools T would be self-reacting and therefore not require a support base B.

Referring to FIG. 3 of the drawings, a simplified example of a panel module 1 is illustrated. The panel module 1 comprises a first member 2 in the form of an elongate stiffening member (e.g. a stringer) with a constant cross-sectional profile (at least over a part of its length shown), and a second member 3 in the form of an area member, such as a skin panel, that is substantially flat or plane. In a preferred embodiment of the invention, the panel module 1 is produced or fabricated by firstly positioning and holding the stiffening member 2 such that it extends in a desired orientation over or across one side of the skin panel 3. To this end, a clamping mechanism (not shown), e.g. at a panel module assembly station S, may be employed. The stiffening member 2 is then welded to the skin panel member 3. In this particular example, the weld may be formed as a T-joint, but other weld joint configurations, e.g. a butt-welded joint 4, may be contemplated depending on the geometry and arrangement of the stiffening member 2 and the skin panel 3. After welding, residual stresses induced in the aluminium material by the thermal stresses that develop during formation of the welded joint 4 and/or that are caused by a change of the material microstructure within the joint 4 can produce distortions D in the module 1. FIG. 3 of the drawings (left-hand side), for example, gives an exaggerated representation of the type of distortions D obtained after welding the stringer 2 onto the skin panel 3 (e.g. the so-called “Zeppelin effect”).

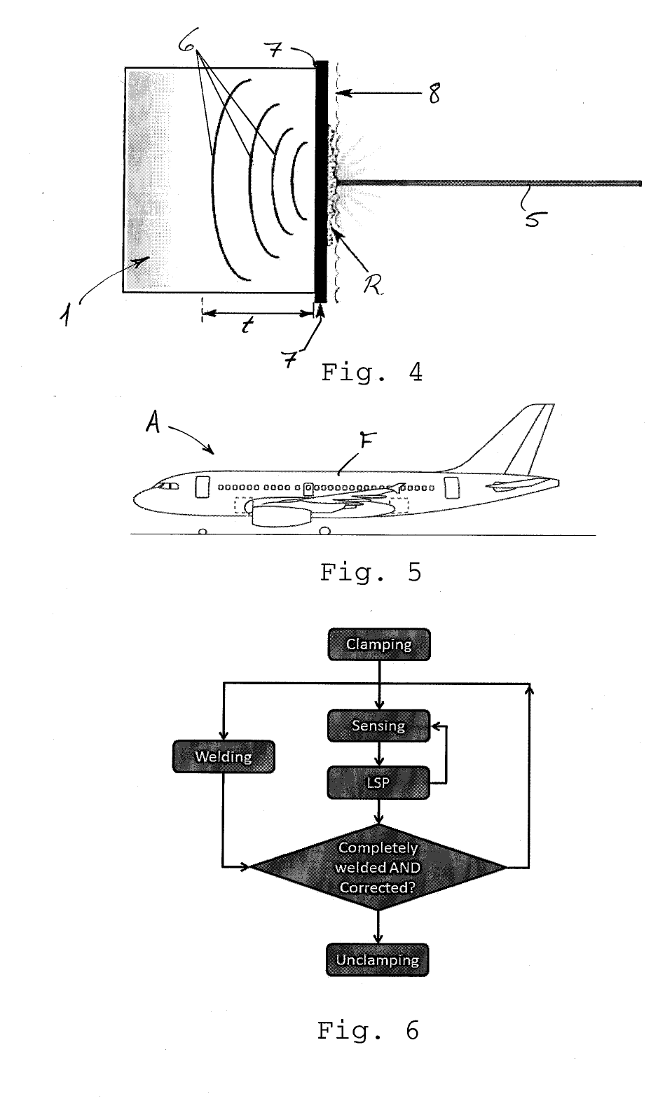

Referring now to FIG. 4 of the drawings, the panel module assembly station S of this embodiment includes a laser shock peening head or laser peening equipment for generating a high energy pulsed laser beam 5 and directing that beam 5 onto a region R of the panel module 1 after the first stiffening member (e.g. stringer) 2 has been welded to the second member (i.e. skin panel) 3. This laser beam 5 is used to drive a high amplitude shock wave 6 into the aluminium alloy material of the panel module 1 using a high impulse beam. In this regard, a coating layer 7, such as of a black tape or paint, may be applied to absorb the energy of the laser beam 5 in the peening process. Short energy pulses are then focused to explode the ablative coating, producing a shock wave 6 with the laser. The peak pressure of the shock wave 6 is greater than the yield strength of the aluminium material and produces local plastic deformation in the aluminium alloy, which induces compressive residual stresses into the depth of the material required for correction or compensation of the distortions D. The beam 5 may be re-positioned and the process repeated to create an array of slight compression indentations with about 5-7% cold work. By repeating the laser peening process over region R a number of times until a desired compression level is reached, a compressive layer with an average depth of 1-2 mm may be formed.

Undesirable thermal effects caused by the laser shock peening beam 5 in this embodiment can be avoided by providing a fluid overlay 8 which is transparent to the laser beam but confines the plasma generated. For example, the fluid overlay 8 may be in the form of a layer of water flowing over a surface of the panel 3. This liquid layer 8 provided over the coating also acts as a tamp, directing the shock wave 6 into the treated material. The non-uniform residual stress distribution that is generated through a thickness t of the aluminium material in the panel module 1 itself leads to deformation which can be precisely controlled for shape correction of the initially distorted parts. Thus, in this way, the production method of this embodiment creates substantial cost reductions and time efficiencies in that the distortions D created by the welding can be corrected in the same manufacturing operation, i.e. during welded assembly of the panel module 1 (i.e. at the panel module assembly station S or with the fabrication equipment or system) without creating additional lead time and correspondingly increased cost by separate manufacturing operations required to further process the panel modules.

Because both laser beam welding (LBW) and laser shock peening (LSP) are repeatable processes, it is conceivable that the laser shock peening via laser beam 5 would be performed or carried out during and/or directly after the welding on the still clamped structure. Alternatively, or in addition, it is conceivable that the laser shock peening via the laser beam 5 may occur or take place during welding to achieve near-zero distortion after unclamping. In such a case, the laser shock peening could be based upon expected distortion derived from previous experience with the particular welding operation. The control of the laser shock peening could also be based on a model of the welding process, and/or on measurements of the distortion generated in the first or second members 2, 3 of the module 1 during welding; for example, via reaction force measurements in the clamping mechanism or via surface strain in the panel module 1.

FIG. 5 of the drawings shows an aircraft A according to an embodiment of the invention, having a fuselage structure F which incorporates a number of panel modules 1 that have been fabricated according to the method of the invention, such as described above with reference to drawing FIGS. 1 to 4.

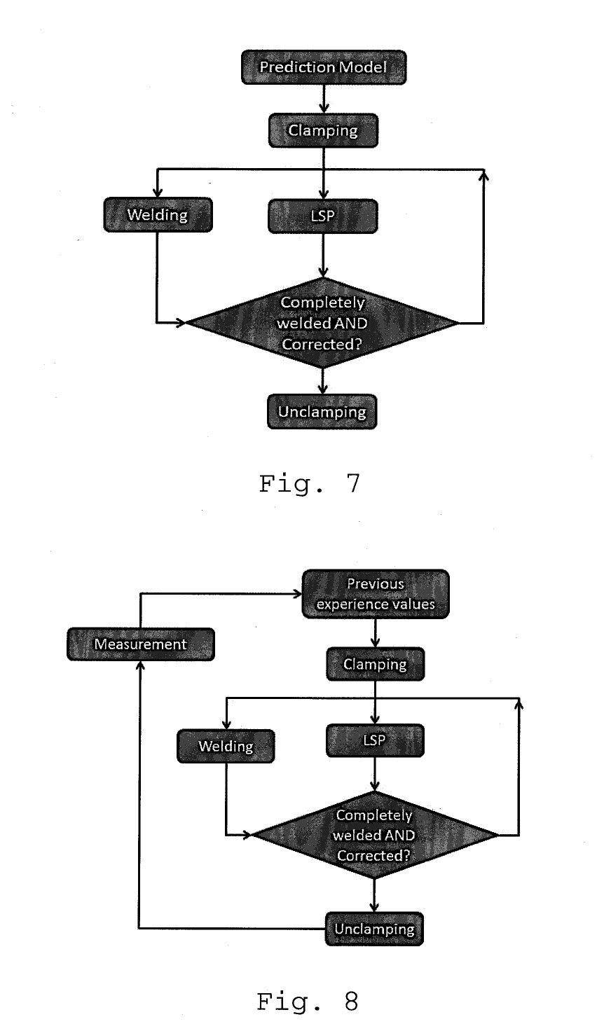

Referring now to FIG. 6 of the drawings, a flow diagram is shown that schematically illustrates the steps in a method of fabricating a panel module 1 for the airframe or fuselage structure F of the aircraft A according to the embodiment of the invention described above with respect to FIGS. 1 to 4. In this regard, the first box of FIG. 6 labelled “clamping” represents the step of positioning and clamping the first member 2 (i.e. elongate stiffening member or stringer 2) at the assembly station S so that it extends over one side or surface of the area member or skin panel 3. After positioning and clamping the first and second members 2, 3, the method of FIG. 6 includes steps or procedures that run or are carried out in parallel. The box at the left-side labelled “welding” represents the step of welding the stiffening member 2 to the panel 3 to produce a panel module 1 having a welded joint 4 between the stringer 2 and the skin panel 3; e.g. a T-joint 4 that extends the length of the stringer 2. During the welding step, one or more sensors provided on the stringer 2, on the skin panel 3, and/or in the clamping mechanism and associated measuring equipment act to simultaneously sense and measure deformation occurring in the module 1 as a result of the welding, as denoted by the box labelled “sensing”. Based on the deformation D detected or sensed by the sensors, the box labelled “LSP” represents the step of laser shock peening the panel module 1 (i.e. region R of the stringer 2 or panel 3) via a laser beam 5 to correct or to compensate for that deformation D. A feed-back loop in the process controller represented by the diamond-shaped box in FIG. 6 assesses the progress of the welding step and the LSP deformation correction (e.g. via the sensors). If the welding and/or the LSP distortion correction is not yet complete, both of these parallel process steps continue. Once the feed-back loop of the process controller determines that both welding of the first and second members 2, 3 and the deformation correction of the module 1 is complete, the final box in FIG. 6 of the drawings labelled “unclamping” then represents the step of releasing the completely welded and deformation corrected panel module 1 from the clamping mechanism at the assembly station S.

FIG. 7 of the drawings shows a flow diagram that illustrates a method of forming or fabricating a panel module 1 according to another embodiment for the airframe or fuselage structure F of the aircraft A. The method of this embodiment involves, or is based on, the use of a model, i.e. a prediction model, to estimate the extent and/or degree of deformation to occur during welding. As before, after the “clamping” step, the “welding” step and the laser peening (i.e. “LSP”) step take place or are carried out in parallel or simultaneously. In this case, though, instead of directly measuring or sensing the deformation D in the module 1 caused by welding, the prediction model is used as the basis for controlling and carrying out the laser shock peening (LSP) of the members of the panel module 1 to correct or compensate for deformation. Again, a feed-back loop in the process controller represented by the diamond-shaped box in FIG. 7 assesses the progress of the welding and the LSP steps. Once the controller determines that both the welding step and LSP step have been completed, the panel module 1 is released or unclamped from the clamping mechanism at the assembly station S.

FIG. 8 of the drawings shows a flow diagram that illustrates a method of forming or fabricating a panel module 1 according to a further embodiment. In this embodiment, the method uses or is based upon previous experience values in the production or fabrication of other modules 1, instead of the prediction model in the method of FIG. 7. In other words, the “previous experience values” are used as the basis for controlling and carrying out the laser shock peening (LSP) of the members of the panel module 1 to correct or compensate for deformation. In other respects, however, the method of FIG. 8 corresponds largely to the method of FIG. 7. The other difference is the fact that, at the end of the method shown schematically in FIG. 8, values denoting extent and degree of the LSP employed in the specific method are recorded in the step represented by the box labelled “measurement” and are fed back into the box “previous experience values” to contribute to the control of subsequent production runs.

Although the embodiments of the method shown schematically in FIGS. 6 to 8 employ different techniques to control LSP for correction or compensation of deformations caused by welding, it will be appreciated that any two or more of the techniques or steps may be used in combination also.

Although specific embodiments of the invention have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

In this document, the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of my contribution to the art.

1. A method of fabricating a module for an airframe or fuselage structure of an aircraft or spacecraft, comprising:
positioning a first member adjacent to a second member at an assembly station;
welding the first member to the second member at the assembly station to produce a module having a welded joint between the first and second members; and
peening at least one of the first member, the second member, and the welded joint at the assembly station to correct or compensate for distortion caused by the welding.

2. The method according to claim 1, wherein the peening is carried out at least one of before, during and after the welding.

3. The method according to claim 2, wherein the first member is a stiffening member, such as an elongate member with a regular transverse cross-section, and wherein the second member is an area member, such as a panel, with a multi-dimensional major surface.

4. The method according to claim 1, wherein the peening comprises generating residual compressive stresses in a surface region of the module, and wherein the peening further comprises generating a shock wave in a region of at least one of the first member, the second member, and the welded joint with a laser beam, such that a peak pressure of the shock wave exceeds a dynamic yield strength of a material of the module.

5. The method according to claim 1, wherein the peening comprises imparting laser beam pulses to at least one of the first member, the second member, and the welded joint of the module through at least one of a coating and an overlay comprising a liquid layer.

6. The method according to claim 1, comprising:
clamping the first member to the second member during the welding step; and
sensing a distortion of the module at least one of during and after the welding from at least one of a clamping reaction force and a surface strain.

7. The method according to claim 1, comprising:
sensing a distortion of the module at least one of during and after the welding; and
controlling the peening based on the sensed distortion of the module.

8. The method according to claim 1, further comprising controlling the peening based on at least one of: a measured distortion of the module, a predictive model of the welding and an analysis of a previously corrected welded module.

9. The method according to claim 1, wherein welding the first member to the second member comprises at least one of laser beam welding, friction stir welding and butt welding.

10. A system for fabricating a module for an airframe or fuselage structure of an aircraft or spacecraft, comprising:
a frame configured to position and hold a first member with respect to an adjacent second member;
a welding head configured to produce a welded joint between the first member and the second member held by the frame; and
a treatment head configured to correct or compensate for distortion in the module caused by welding.

11. The system according to claim 10, wherein the welding head includes at least one of a laser and laser emitter for laser beam welding, wherein the welding head includes a laser shock peening head.

12. The system according to claim 10, wherein the frame includes a clamping device for holding the first member fixed to the second member.

13. The system according to claim 10, comprising a sensor device for sensing a distortion of the module at least one of during and after the welding based on at least one of a clamping reaction force and a surface strain.

14. The system according to claim 10, comprising a computer controller for controlling the treatment head based on at least one of: a sensed distortion of the module, a measured distortion of the module, a predictive model of the welding, and an analysis of a previously corrected welded module.

15. A method of fabricating a module for an airframe or fuselage structure of an aircraft or spacecraft, comprising:
positioning a first member adjacent to a second member at an assembly station;
welding the first member to the second member at the assembly station to produce a module having a welded joint between the first and second members; and
peening at least one of the first member, the second member, and the welded joint at the assembly station to correct or compensate for distortion caused by the welding, wherein the peening comprises generating residual compressive stresses in a surface region of the module, wherein the peening further comprises generating a shock wave in a region of at least one of the first member, the second member, and the welded joint.

16. The method according to claim 15, wherein the shock wave exceeds a dynamic strength of a material of the module.

17. The method according to claim 15, wherein generating residual compressive stresses is performed by at least one of laser peening, shot peening, and sand-blasting.

18. The method according to claim 15, further comprising:
sensing a distortion of the module at least one of during and after the welding; and
controlling the peening based on the sensed distortion of the module.
